(19) United States
(12) Patent Application Publication
(10) Pub. No.: US 2021/0194716 A1
(43) Pub. Date: Jun. 24, 2021

(54) METHODS AND DEVICES TO MANAGE ACTION OF REMOTE ELECTRONIC DEVICES

(71) Applicant: Lenovo (Singapore) Pte. Ltd., New Tech Park (SG)

(72) Inventors: Nathan J. Peterson, Oxford, NC (US); Nicholas Richard Roberts, Cary, NC (US); Brian Jules Jaeger, Wake Forest, NC (US); Joshua N. Novak, Wake Forest, NC (US)

(21) Appl. No.: 16/720,365

(22) Filed: Dec. 19, 2019

(51) Int. Cl. H04L 12/28; G10L 15/22

(52) U.S. Cl. CPC H04L 12/2812; H04L 12/282; H04L 12/2827; G10L 2015/223; H04L 12/2814; H04L 2012/2841; H04L 2012/2849; G10L 15/22

(57) ABSTRACT

Methods, devices and computer program products are provided that, under control of one or more processors configured with executable instructions, receive a user-generated device agnostic instruction (DAI) at a local electronic device having digital personal assistant (DPA) functionality; determine whether the local electronic device is in an operational state that supports implementation of the DAI; based on the determining, transmit the DAI to one or more remote electronic devices having DPA functionality; and implement the DAI at each of the one or more remote electronic devices that is in an operational state that supports implementation of the DIA.

### FIELD

The present disclosure relates generally to methods and devices that manage action of remote electronic devices based on device agnostic instructions.

### BACKGROUND OF THE INVENTION

In today's technology driven society, many users own multiple electronic devices that can be used for different types of communications, different tasks, and/or at different locations. For example, a user may own multiple digital personal assistant (DPA) devices that are distributed throughout a home.

Generally, a DPA device is an electronic device with a user interface that simulates human traits that allows a human user to interact with the electronic device in a manner similar to interacting with another person, rather than a machine. For example, the DPA device may include a voice recognition system that interprets the voice input of the user and executes services or perform tasks in response thereto. The DPA device also includes a voice interface to audibly respond to the user in a natural language form. Typically, a DPA device operates on a single device with dedicated components to interact with the user. For example, the DPA device may have a built-in microphone to receive user requests and a built-in speaker to provide communications. In addition, the DPA device can include a component interface that can connect to wired or wireless electronic devices, such as smart phones, smart televisions, tablets, smart watches, smart appliances, and speakers to control operation of the electronic devices.

However, conventional DPA devices cannot communicate with or process commands for other DPA devices. Today, DPA devices and many other types of electronic devices operate independent of one another in standalone configurations. Instead, a user is required to provide separate instructions to each DPA device in order to direct the DPA device to perform an action of interest. For example, when a first DPA device in one room is playing music, if the user moves to a different room having a second DPA device and decides to watch TV instead of listen to music, the user must return to and provide a separate instruction for the first DPA device to stop playing music.

Accordingly, a need remains for methods and devices that enable managing actions of one or more remote DPA devices, or electronic devices controlled thereby, based on instructions received at a local DPA device.

### SUMMARY

In accordance with embodiments herein, a method is provided that comprises, under control of one or more processors configured with executable instructions, receiving a user-generated device agnostic instruction (DAI) at a local electronic device having digital personal assistant (DPA) functionality; determining whether the local electronic device is in an operational state that supports implementation of the DAI; based on the determining, transmitting the DAI to one or more remote electronic devices having DPA functionality; and implementing the DAI at each of the one or more remote electronic devices that is in an operational state that supports implementation of the DIA.

Additional or alternatively, the DAI comprises an instruction that includes one or more of a command and an action to implement and does not designate the local or remote electronic device on which to implement the one or more of the command and the action. Additional or alternatively, the DAI may be transmitted to all (or multiple) of the one or more remote electronic devices having the DPA functionality. Additional or alternatively, the method further comprises: transmitting a DAI inquiry to the one or more remote electronic devices; receiving DAI response data from the one or more remote electronic devices; determining at least one DAI-capable remote electronic device, from the one or more remote electronic devices, based on the DAI response data; and transmitting the DAI to at least one DAI-capable remote electronic device for implementation thereon.

Additional or alternatively, the determination of at least one DAI-capable remote electronic device further comprises analyzing DAI response data to obtain information indicative of the capability of each of the one or more remote electronic devices to implement the DAI. Additional or alternatively, the determination of at least one DAI-capable remote electronic device further comprises analyzing DAI response data to obtain additional information about each of the one or more remote electronic device, the additional information including one or more of the device name, device location, device manufacturer, device make, device model, device version, other activities currently performed by the device, and other activities scheduled to be performed by the device. Additional or alternatively, the determination of at least one DAI-capable remote electronic device includes determining a plurality of DAI-capable remote electronic devices based on the DAI response data; the method further comprising prompting a user to specify the identity of select devices of the plurality of DAI-capable remote electronic devices to implement the DAI on. Additional or alternatively, the DAI includes an instruction to play, pause, or cease to play one or more of audio or video streaming content, the operational state of the local electronic device not supporting implementation of the DAI, but the operational state of at least one of the remote electronic devices supporting implementation of the DAI. Additional or alternatively, the DAI includes an instruction to one or more of turn on a device function, turn off a device function, or adjust a setting of a device control controlled by the one or more remote electronic device.

In accordance with embodiments herein, a local electronic device is provided that comprises: an input to receive a user instruction to perform an action; one or more processors; a memory storing program instructions accessible by the one or more processors, wherein, responsive to execution of the program instructions, the one or more processors perform the following: receive a user-generated device agnostic instruction (DAI) at the local electronic device having digital personal assistant (DPA) functionality; determine whether the local electronic device is in an operational state that supports implementation of the DAI; based on the determine, transmit the DAI to one or more remote electronic devices having DPA functionality; and implement the DAI at each of the one or more remote electronic devices in an operational state that supports implementation of the DIA; and a transceiver to transmit the DAI to the one or more remote electronic device.

Additionally or alternatively, the DAI comprises an instruction that includes one or more of a command or an action to implement and does not designate the local or remote electronic device on which to implement the one or more of the command and the action. Additional or alternatively, the one or more processors are further configured to: transmit a DAI inquiry to the one or more remote electronic devices; receive DAI response data from the one or more remote electronic devices; determine at least one DAI-capable remote electronic device, from the one or more remote electronic devices, based on the DAI response data; and transmit the DAI to at least one DAI-capable remote electronic device for implementation thereon. Additionally or alternatively, the one or more processor are configured to, as part of the determine at least one DAI-capable remote electronic device, analyze DAI response data to obtain information indicative of the capability of each of the one or more remote electronic devices to implement the DAI. Additionally or alternatively, the one or more processor are configured to, as part of the determine at least one DAI-capable remote electronic device, analyze DAI response data to obtain additional information about each of the one or more remote electronic device, the additional information including one or more of the device name, device location, device manufacturer, device make, device model, device version, other activities currently performed by the device, and other activities scheduled to be performed by the device. Additionally or alternatively, the one or more processor are configured to, as part of the determine at least one DAI-capable remote electronic device, determine a plurality of DAI-capable remote electronic devices based on the DAI response data; wherein the one or more processor are further configured to prompt a user to specify the identity of select devices of the plurality of DAI-capable remote electronic devices to implement the DAI on.

Additionally or alternatively, the one or more processors are configured to: determine that the local electronic device is in an operational state that supports implementation of the DAI; implement the DAI in connection with the operational state of the DPA functionality of the local electronic device; and further transmit the DAI to the one or more remote electronic devices having the DPA functionality for implementation at each of the one or more remote electronic devices in the operational state that supports implementation of the DIA.

In accordance with embodiments herein, a computer program product is provided comprising a non-signal computer readable storage medium comprising computer executable code to: receive a user-generated device agnostic instruction (DAI) at a local electronic device having digital personal assistant (DPA) functionality; determine whether the local electronic device is in an operational state that supports implementation of the DAI; based on the determine, transmit the DAI to one or more remote electronic devices having DPA functionality; and implement the DAI at each of the one or more remote electronic devices in an operational state that supports implementation of the DIA.

Additionally or alternatively, the DAI comprises an instruction that includes one or more of a command or an action to implement and does not designate the local or remote electronic device on which to implement the one or more of the command and the action. Additionally or alternatively, the computer executable code is further configured to: transmit a DAI inquiry to the one or more remote electronic devices; receive DAI response data from the one or more remote electronic devices; determine at least one DAI-capable remote electronic device, from the one or more remote electronic devices, based on the DAI response data; and transmit the DAI to at least one DAI-capable remote electronic device for implementation thereon. Additionally or alternatively, the computer executable code is further configured to, as part of the determine at least one DAI-capable remote electronic device, analyze DAI response data to obtain information indicative of the capability of each of the one or more remote electronic devices to implement the DAI.

### BRIEF DESCRIPTION OF THE DRAWINGS

FIG. 1 illustrates a system for managing actions of one or more remote electronic devices based on device agnostic instructions received at a local electronic device in accordance with embodiments herein.

FIG. 2 illustrates a top plan view of an environment in which embodiments herein may be implemented.

FIG. 3A illustrates an example process for managing actions of one or more remote electronic devices based on device agnostic instructions received at a local electronic device in accordance with embodiments herein.

FIG. 3B illustrates an example process for managing actions of one or more remote electronic devices based on device agnostic instructions received at a local electronic device in accordance with embodiments herein.

FIG. 4 illustrates an example process for managing actions of one or more remote electronic devices based on device agnostic instructions received at a local electronic device in accordance with embodiments herein.

FIG. 5 illustrates an example of communications between a plurality of remote electronic devices and a local electronic device based on device agnostic instructions received at a local electronic device in accordance with embodiments herein.

FIG. 6 illustrates an example of communications between a plurality of remote electronic devices and a local electronic device based on device agnostic instructions received at a local electronic device in accordance with embodiments herein

### DETAILED DESCRIPTION

It will be readily understood that the components of the embodiments as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

It should be clearly understood that the various arrangements and processes broadly described and illustrated with respect to the Figures, and/or one or more individual components or elements of such arrangements and/or one or more process operations associated of such processes, can be employed independently from or together with one or more other components, elements and/or process operations described and illustrated herein. Accordingly, while various arrangements and processes are broadly contemplated, described and illustrated herein, it should be understood that they are provided merely in illustrative and non-restrictive fashion, and furthermore can be regarded as but mere examples of possible working environments in which one or more arrangements or processes may function or operate.

### Terms

The term “instruction context information” shall mean information indicative of a context of an instruction for an electronic device that includes DPA device functionality. The context of an instruction is indicative of one or more operational state at an electronic device that, when present, allows implementation of the instruction on the electronic device. Nonlimiting examples of instruction context information include whether an instruction pertains to playing, pausing, or ceasing to play music, movies, television programming or other audio and/or video streaming content, whether an instruction pertains to a specific type of function and/or type of connected electronic device, an activity state context, and the like. For example, an electronic device needs to have an operational state of “playing music” in order to implement an instruction to stop or pause playing music. In an additional or alternative example, an electronic device needs to be playing audio content to implement an instruction to turn up or down volume. In an additional or alternative example, an electronic device needs to be playing a movie to implement an instruction to change a channel.

The term “device agnostic instruction” and “DAI” shall refer to an instruction that includes a command and/or action to be implemented, without designating a specific one or more electronic devices to implement the command and/or action. The DAI may be capable of implementation by one or more electronic devices in an environment depending on one or more operational states present at the one or more electronic devices. Nonlimiting examples of DAI include instructions to play, pause, or cease to play music, movies, television programming, or other audio and/or video streaming content, instructions to execute a specific type of function (e.g., turn lights on or off), and instructions to adjust a setting of a control (e.g., adjust a volume setting, adjust a temperature setting, and the like), without designating a particular electronic device to implement the action.

The term “environment” refers to a physical region i) surrounding one or more electronic devices that communicate with one another and ii) in which implementations of DPA functions is at least partially perceivable by individuals. By way of example, an environment may refer to one or more rooms within a house, office or other structure. An environment may or may not have physical boundaries. For example, an environment may refer to one or more of a pool area, a deck, a backyard, exterior areas outside of an office, a commercial area, either alone or in addition to one or more rooms in a house, office, or other structure, where approximate virtual boundaries of the environment correspond to the range over which operational states at and/or actions performed by and/or controlled by at least one device of a plurality of devices having DPA functionality may be heard, seen, felt or otherwise perceived by individuals when present in at least a portion of the environment.

The term “digital personal assistant”, “DPA”, “virtual assistant”, “intelligent digital assistant”, as used throughout, shall generally refer to functionality of any electronic device that has a user interface or information processing system that uses a voice recognition system, such as a Natural language understanding (NLU), automatic speech recognition (ASR), or text-to-speech synthesis (TTS), to interpret natural language input in spoken form and/or textual form to infer intent, and perform actions based on an inferred user intent. DPA devices may also include a component interface that can connect to and control wired or wireless electronic devices, such as smart phones, smart televisions, tablets, smart watches, smart appliances, and speakers to control operation of the electronic devices. For example, a digital personal assistant may receive a user instruction in the form of a natural language command, request, statement, narrative, and/or inquiry. A user instruction may seek either an informational answer or performance of an action by the digital personal assistant. Accordingly, the digital personal assistant can perform the requested action, send a control signal via the component interface to a connected electronic device to perform the requested action, and/or provide responses in audio and/or visual form, such as natural language, music, video, text, animations, etc.

The term “operational state” shall mean a state of operation of an electronic device having DPA functionality. Nonlimiting examples of operational states include streaming music, movies, television programming or other audio and/or video streaming content, having an “ON” operational state for a function, having an “OFF” operational state for a function, and the like.

The term “DAI-capable” shall refer to electronic devices that have DPA functionality and are able to implement a device agnostic instruction when in a corresponding operational state.

### Overview

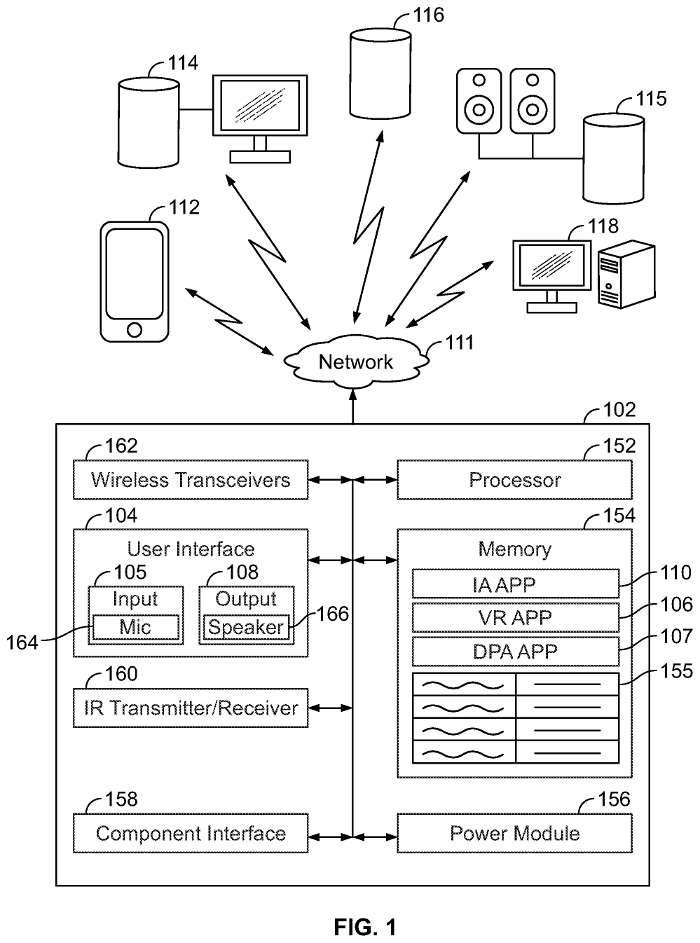

FIG. 1 illustrates a system 100 for managing action of remote electronic devices based on a DAI received at a local electronic device in accordance with embodiments herein. The system 100 includes a local electronic device 102 and one or more remote electronic devices 112-116. The local electronic device 102 is configured to provide DPA device functionality. For example, the local electronic device 102 may represent an Amazon Echo® device, Google Home device, and the like. In another example, the one or more remote electronic devices 112-116 may represent the same type or different types of device as the local electronic device 102 and are also configured to provide DPA device functionality. Each of the one or more remote electronic devices 112-116 include all of the features and functionality discussed in conjunction with the local electronic device 102. The one or more remote electronic devices 112-116 may be speakers, home theater systems, computers, tablet devices, mobile phones, televisions, communication content players, smart watches, smart appliances, and the like. Each of the electronic devices 102, 112-116 is capable of processing received DAI, communicating requests associated with DAI to the other electronic devices in an environment, and transmitting DAI to one or more responsive electronic devices over the network 111 or other type of connection. It is to be understood that the local and remote designations are relative only to the one of the electronic devices 102, 112-116 that receives and processes the DAI. Any one of the electronic devices 102, 112-116 can be either the local electronic device 102 or one of the one or more remote electronic devices 112-116.

As shown in FIG. 1, the local electronic device 102 includes components such as one or more processors 152 (e.g., a microprocessor, microcomputer, application-specific integrated circuit, etc.), one or more local storage medium (also referred to as a memory) 154, a user interface 104 which includes one or more input circuits 105 and one or more output circuits 108, a power module 156, a component interface 158, an infrared (IR) transmitter/receiver 160 and one or more wireless transceivers 162. All of these components can be operatively coupled to one another, and can be in communication with one another, by way of one or more internal communication links, such as an internal bus.

The input circuit 105 receives user instructions in various manners, such as using a voice recognition (VR) application 106. The processors 152 execute instructions stored in the memory 154 to interpret and perform actions based on user instructions that are received through the input circuit 105. The user instruction may represent requests of various types. By way of example, some types of user instructions seek information, such as a question that may be answered by the local electronic device 102 based on content stored therein and/or an automated searched over the Internet and the like. Other types of user instructions may instruct one or more electronic devices 102 to perform various types of actions and/or execute various types of commands, as described herein.

An instruction administration (IA) application 110 receives user-generated DAI, identifies instruction context information associated with the DAI, and determines whether an operational state is such that the DAI can be performed on the local electronic device 102. Based on the IA application 110 determining that the instruction context information associated with the DAI corresponds to one or more operational state at the local electronic device 102, the local external device 102 implements the DAI. Based on the IA application 110 determining that the instruction context information associated with the DAI does not correspond to one or more operational state at the local electronic device 102, the IA application transmits a DAI inquiry to one or more remote electronic devices 112-116 in the environment and receives DAI response data from the one or more remote electronic devices 112-116. The IA application 110 determines one or more remote device capable of performing the DAI based on the DAI response data and transmits the DAI to at least one DAI-capable remote device for implementation thereon. The local electronic device 102 communicates with the one or more remote electronic devices 112-116 over the network 111, such as through a wireless transceiver 162, and/or over a separate wired or wireless link there between. For example, an auxiliary output may be used to form a wired connection. Optionally, a Bluetooth link or other wireless link may be utilized for a direct wireless connection. The electronic devices 112-116 operate in connection with corresponding regions of the environment that may be separate and distinct from one another, partially overlap, wholly overlap, and/or vary over time with movement of the corresponding local electronic device 102 and/or remote electronic device 112-116.

The local electronic device 102 includes an output circuit 108 and transceiver 202, one or both of which may output incoming and/or modified DAI, and associated requests, to the one or more remote electronic devices 112-116. The local electronic device 102 includes a voice recognition type user interface 104 and is configured to access the network 111 over a wired or wireless connection. As non-limiting examples, the local electronic device 102 may access the network 111 through a wireless communications channel and/or through a network connection (e.g., the Internet). Additionally or alternatively, the local electronic device 102 may be a wired or wireless communication terminal, such as a desktop computer, laptop computer, network-ready television, set-top box, and the like.

The local electronic device 102 is configured to access the network resources 118, including web-based or network-based data, applications, and services, via the network 111. The network 111 may represent one or more of a local area network (LAN), a wide area network (WAN), an Intranet or other private network that may not be accessible by the general public, or a global network, such as the Internet or other publicly accessible network. The network 111 provides communication between the local electronic device 102, the one or more remote electronic devices 112-116, and one or more network resources 118. It will be understood that, in some embodiments, the network resources 118 may represent a single entity or one or more physical or virtual servers that are configured to deliver online resources to the local electronic device 102. Examples of the network resources 118 include, but are not limited to, web-based or network-based data storage services, social networking applications, shopping services, payment services, multimedia content delivery services, financial services and the like. The resources 118 may represent a Web service or a network service for an e-commerce business, financial institution, or any other commercial, noncommercial, personal, nonprofit or other entity.

The user interface 104 permits the user to operate the local electronic device 102 for any of its intended purposes, such as administering the IA application 110, operating software applications, electronic communication, listening to audio media, and the like. The input circuit 105 can include one or more audio input circuits, such as a microphone 164 that is configured to receive audio input (e.g., instructions, requests) from the user. The output 108 can include one or more electronic devices, such as a speaker 166, that are configured to communicate notification alerts or notification content to the user. In association with the VR application 106, the user interface 104 allows the user to communicate with the local electronic device 102 by receiving audio input in the form of natural language. The VR application 106 may interpret the audio input received by the input circuit 105 and may generate communication content, such as a voice interface to audibly respond to the user in a natural language form. When the audio input represents an instruction, the VR application 106 passes the instruction to the IA application 110 to be processed as described herein.

Optionally, the input and output circuits 105, 108 may each include a variety of visual, audio, and/or mechanical devices. For example, the input circuit 105 can include a visual input device, such as an optical sensor or camera, and/or a mechanical input circuit such as a keyboard, keypad, selection hard and/or soft buttons, switch, touchpad, touch screen, icons on a touch screen, a touch sensitive areas on a touch sensitive screen and/or any combination thereof. Similarly, the output circuit 108 can include a visual output circuit such as a liquid crystal display screen, touch sensitive screen, a non-touch sensitive screen, a text-only display, a smart phone display, an audio output (e.g., a speaker or headphone jack), and/or any combination thereof and/or one or more light emitting diode indicators. The output circuit 108 is integral to (e.g., within a common housing) the local electronic device 102.

The memory 154 may encompass one or more memory devices of a variety of forms (e.g., read only memory, random access memory, static random access memory, dynamic random access memory, etc.) and can be used by the processor 152 to store and retrieve data. The data that is stored by the memory 154 can include, but need not be limited to, operating systems, applications, user collected content, and informational data. Each operating system includes executable code that controls basic functions of the device, such as interaction among the various components, communication with external devices via the wireless transceivers 162, the component interface 158, and/or the IR transmitter/receiver 160, and storage and retrieval of applications and data to and from the memory 154. Each application includes executable code that utilizes an operating system to provide more specific functionality for the communication devices, such as file system service and handling of protected and unprotected data stored in the memory 154.

The memory 154 stores various content including, but not limited to, the VR application 106, the IA application 110 and a DPA device application 107. The DPA device application 107 interacts with the VR application 106 to provide voice recognition. The DPA device application 107 interprets natural language input in spoken form or text form, infers intent therefrom, and perform actions based on the inferred intent on the local electronic device 102. The VR and IA applications 106, 110 manage one or more operations of the local electronic device 102. The VR and IA applications 106, 110 include instructions accessible by the one or more processors 152 to direct the processor 152 to implement the methods, processes and operations described herein including, but not limited to, the methods, processes and operations illustrated in the Figures and described in connection with the Figures. In an alternative embodiment, the VR and IA applications 106, 110 may operate from one or more storage medium (also referred to as cloud storage). The memory 154 may also store one or more lists 155 that contain one or more remote electronic devices 112-116 that are registered for use within the network 111 and/or within an environment. The one or more remote electronic devices 112-116 may be added to the list 155 at the time the electronic device is registered. The list 155 may include unique identifying information for each of the electronic devices thereon, as well as operating characteristics or attributes of the electronic devices that may be relevant to the types of actions that the electronic devices may be able to perform. For example, the characteristics or attributes may indicate that a remote electronic device 115 is connected to a stereo system, a remote electronic device 116 is operating independently, and a remote electronic device 114 is connected to a smart television.

Among other things, the IA application 110 manages operation of the processor 152 in association with identifying DAI, identifying instruction context information associated with the DAI, determining whether the DAI can be performed on the local electronic device 102 while in a present operational state, and, if not, determining whether one or more remote devices 112-116 are in an operational state that will support the DPA functionality to perform the DAI, and, if so, transmitting the DAI to at least one of the one or more remote device capable of performing the DAI. The processor 152 may identify the instruction context information based on one or more of a type of instruction, a type of action to be performed and/or command to be implemented, and/or a type of operational state required to implement the DAI at the electronic device 102.

The processor 152 identifies the capability of the one or more remote electronic devices 112-116 operatively connected to the local electronic device 102 with respect to implementing the DAI. For example, the processor 152 can direct the transceiver 162 to transmit a DAI inquiry request and listen for responses from the electronic devices 112-116. The processor 152 analyzes DAI response data from the responses to obtain information indicative of the capability of each remote electronic device 112-116 with respect to implementing the DAI. Optionally, the processor 152 may analyze data from the responses to obtain additional information about each of the one or more remote electronic devices 112-116. Additional information may include one or more of a device name, a device location, a device manufacturer, a device make, a device model, a device version, other activities currently performed by the device, other activities scheduled to be performed by the device, and the like.

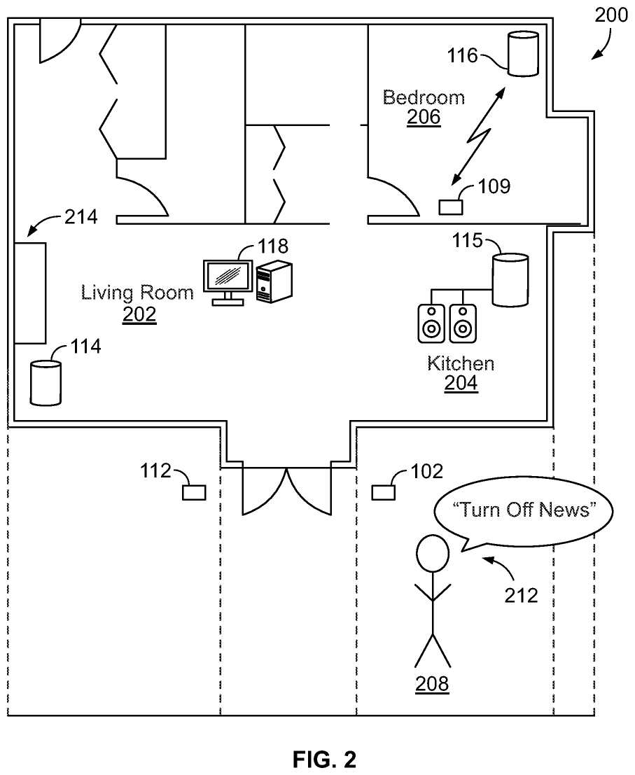

FIG. 2 illustrates a top plan view of an example environment in which embodiments herein may be implemented. The environment 200 may represent a home, office or other structure. In the example of FIG. 2, the environment 200 represents a home with a living room region 202, a kitchen region 204, a bedroom region 206, and an outdoor region 208. The electronic devices 102, 112-116 are shown at representative locations distributed throughout the environment 200. All of the electronic devices 102, 112-116 may offer DPA device functionality. Alternatively, one or more of the electronic devices 102, 112-116 may by operably coupled to and control one or more non-DPA electronic devices 210 through a component control interface. Embodiments herein enable managing action of one or more remote electronic devices 112-116 based on DAI received at the local electronic device 102.

With reference to the example environment of FIG. 2, in one example, when a user is in the outdoor region 208, the user may want to turn off a news broadcast that is streaming on a smart TV operably coupled to and controllable by the remote electronic device 114. The user 212, who is in proximity to local electronic device 102, generates a DAI including a command to turn off the news (e.g., “stop news”, “turn off news”). The local electronic device 102 receives the DAI and identifies that the instruction context information indicates that at least one electronic device must be in an operational state of “streaming news content” in order to implement the DAI including the command to turn off the news. The processor 152 determines that the local electronic device 102 is not streaming news and, thus, determines that the DAI cannot be implemented on the local electronic device 102. The local electronic device 102 is not in an appropriate operational state. Based on determining that the DAI cannot be implemented locally, the local electronic device 102 transmits a DAI inquiry to one or more remote electronic devices 112-116. The one or more remote electronic devices 112-116 receive the DAI, identify that the instruction context information indicates that news content must be streaming in order to implement the DAI including the command to turn off the news, determine whether the DAI can be implemented thereon, and, based thereon, transmit DAI response data to the local electronic device 102. For example, when the smart TV 214 controlled by the remote electronic device 114 is the only device in the environment 200 streaming news content, the remote electronic device 114 would determine that the DAI can be implemented thereon and transmit DAI response data to the local electronic device 102 indicating that the DAI can be implemented thereon. Further, the remaining remote electronic devices 112, 115, 116, 118 would determine that the DAI cannot be implemented thereon and transmit DAI response data to the local electronic device 102 indicating that the DAI cannot be implemented thereon. The local electronic device 102 receives the DAI response data from the one or more remote electronic devices 112-116 and determines that the remote electronic device 114 is capable of implementing the DAI including the command to turn off the news. Based thereon, the local electronic device 102 transmits the DAI to the remote electronic device 114. The remote electronic device 114 implements the command to turn off the news streaming on the smart TV 214 operably coupled thereto without the user 212 having to return to the living room 202.

In an additional or alternative example to the above, based on both the smart TV 214 controlled by the remote electronic device 114 and the remote electronic device 115 represent the only two devices in the environment 200 streaming news content, the remote electronic devices 114, 115 would determine that the DAI can be implemented thereon and transmit DAI response data to the local electronic device 102 indicating that the DAI can be implemented thereon. The local electronic device 102 receives the DAI response data from the one or more remote electronic devices 112-116 and determines that the remote electronic devices 114, 115 are both capable of implementing the DAI including the command to turn off the news.

Optionally, based thereon, the local electronic device 102 may prompt the user to indicate whether to implement the DAI on one or both of the remote electronic devices 114, 115 or on neither of the remote electronic devices 114, 115. For example, the local electronic device 102 may ask the user “Would you like to turn off the news in the living room or the bedroom?” Based on the user's response (e.g., “the living room”, “the bedroom”, “both”, “neither”), the local electronic device 102 transmits the DAI to one or more of the remote electronic devices 114, 115 for implementation thereon without the user 212 having to return to the living room and/or the kitchen.

In the present example, the remote electronic devices 114, 116 are shown to have a wireless communications link with another activity or control circuits implemented in other non-DPA devices. For example, the remote electronic device 114 has a wireless communications link with the smart TV 214 as discussed above. In an additional or alternative example, the remote electronic device 116 has a wireless communications link with an activity or control circuit 210. The activity or control circuit 210 may represent a door lock, a light switch, a lightbulb, a non-DPA content streaming device, a local thermostat, a motion detector, and the like. The remote electronic devices 114, 116 may, based on receiving a DAI inquiry, determine whether the DAI can be implemented thereon. The remote electronic devices 114, 116 may determine whether the DAI can be implemented locally by sending a request to and receiving a response from other activity or control circuits and/or other non-DPA devices operably coupled thereto.

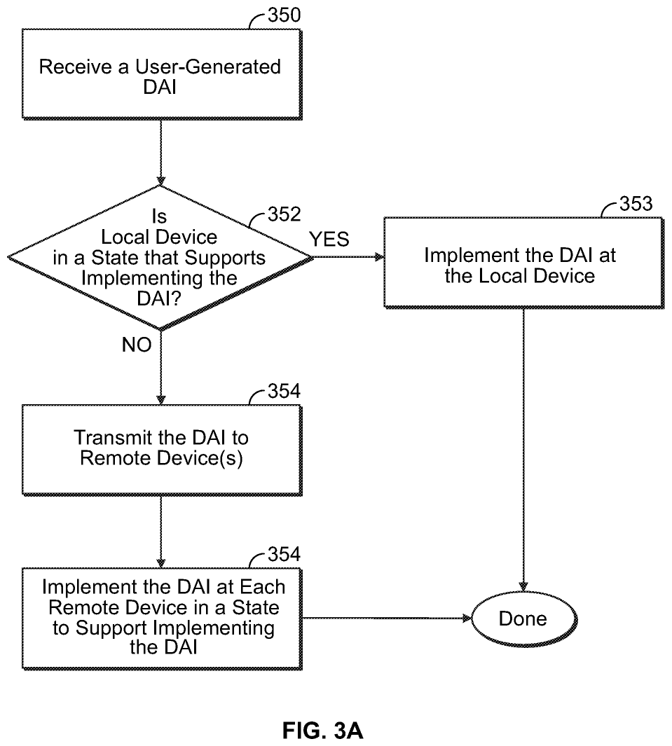

FIG. 3A illustrates an example process for managing actions of one or more remote electronic devices based on device agnostic instructions received at a local electronic device in accordance with embodiments herein. At 350, one or more processors of a local electronic device 102 receive a user-generated DAI. The DAI comprises an instruction that includes one or more of a command and an action to implement and does not designate the local or remote electronic device on which to implement the one or more of the command and the action.

At 352, the one or more processors determine whether the local electronic device is in an operational state that supports implementation of the DAI. Based on determining that the local electronic device 102 is in an operational state that supports implementation of the DAI, flow moves to 353 and the DAI is implemented locally. Based on determining that the local electronic device 102 is not in an operational state that supports implementation of the DAI, flow moves to 354.

At 354, the one or more processors, transmit the DAI to one or more remote electronic devices having DPA functionality based on the determination at 352. By way of example, the DAI may be transmitted to all (or a select multiple) of the one or more remote electronic devices having the DPA functionality. For example, prior to the implantation of the operations of FIG. 3A, the local and remote electronic devices within a predetermined physical environment and/or on a common network may communicate with one another to determine which devices having DPA functionality. Thereafter, when a DAI is received, the electronic device receiving the DAI is designated the local electronic device, while the remainder of the electronic devices in the network are designated remote electronic devices. Given that all of the electronic devices have deviously communicated with one another to determine which devices have DPA functionality, the local electronic device already knows which portion (or all) of the remote electronic devices, to which to transmit that the DAI.

Additionally or alternatively, prior to transmission of the DAI to the remote electronic devices, the local electronic device may engage in a back-and-forth communication with each of the remote electronic devices. During the exchange, the local electronic device transmits a DAI inquiry to the one or more remote electronic devices, and receives DAI response data from the one or more remote electronic devices. The local electronic device determines/identifies at least one DAI-capable remote electronic device, from the one or more remote electronic devices, based on the DAI response data and transmits the DAI to the identified one or more DAI-capable remote electronic device for implementation thereon.

Additionally or alternatively, at 354, when the local electronic device receives DAI response data, the local electronic device may determine the DAI-capable remote electronic devices by analyzing the DAI response data to obtain information indicative of the capability of each of the one or more remote electronic devices to implement the DAI. The local electronic device may analyze the DAI response data to obtain additional information about each of the one or more remote electronic device, the additional information including one or more of the device name, device location, device manufacturer, device make, device model, device version, other activities currently performed by the device, and other activities scheduled to be performed by the device. The local electronic device may determine a plurality of DAI-capable remote electronic devices based on the DAI response data; the method further comprising prompting a user to specify the identity of select devices of the plurality of DAI-capable remote electronic devices to implement the DAI on.

At 356, the DAI is implemented at each of the one or more remote electronic devices that is in an operational state that supports implementation of the DIA. By way of example, the DAI may include an instruction to play, pause, or cease to play one or more of audio or video streaming content, while the operational state of the local electronic device not supporting implementation of the DAI, but the operational state of at least one of the remote electronic devices supporting implementation of the DAI. Additionally or alternatively, the DAI may include an instruction to one or more of turn on a device function, turn off a device function, or adjust a setting of a device control controlled by the one or more remote electronic device.

FIG. 3B illustrates an example process for managing actions of one or more remote electronic devices based on device agnostic instructions received at a local electronic device in accordance with embodiments herein. The process of FIG. 3B may represent a more detailed implementation of the process of FIG. 3A. At 302, one or more processors of a local electronic device 102 receive a user-generated DAI. The local electronic device 102 may represent any type of device that includes DPA functionality. For example, the local electronic device 102 may represent an Amazon Echo® device, Google Home device, and the like. The input circuit 105 of the user interface 104 may receive the user-generated DAI. The DAI is an instruction that includes one or more of a command or an action to implement without an indication of which specific electronic device is to implement the command. As described herein, non-limiting examples of DAI may include an instruction to pause music, a movie or television content, but contain no indication of any specific electronic device on which to implement the command. It is recognized that numerous other types of user instructions may be received and acted upon in connection with embodiments herein.

At 304, the one or more processors identify instruction context information concerning the DAI. The instruction context information is indicative of one or more operational states that must be present in order for the local electronic device 102 to implement the instruction. For example, for DAI that include an instruction directing an electronic device 102 to pause music, a movie or television content, the instruction context information indicates that the local electronic device 102 must be streaming music, a movie or television content, to implement the DAI. Once instruction context information concerning the DAI is identified, flow moves to 306.

At 306, the one or more processors determine whether the DAI can be implemented by the local electronic device 102 based on the instruction context information. For example, based on the instruction context information, the local electronic device 102 determines whether any application under control of the local electronic device 102 is currently streaming music, a movie or television content. Based on determining that an application under control of the local electronic device 102 is currently streaming music, a movie or television content, flow moves to 308. At 308, the one or more processors implement the DAI, thereby pausing the music, the movie or television content, and the process ends. Based on determining that an application under control of the local electronic device 102 is not currently streaming music, a movie or television content, flow moves to 310.

At 310, the one or more processors transmit a DAI inquiry to one or more remote electronic devices 112-116 in an environment. Each of the one or more remote electronic devices 112-116 includes DPA functionality. For example, the processor 152 can direct the transceiver 162 to transmit a DAI inquiry request to the one or more remote electronic devices 112-116. Based on receiving a DAI inquiry from the local electronic device 102, one or more processors of each of the one or more remote electronic devices 112-116 determine whether the DAI can be implemented thereby based on the instruction context information. The instruction context information may be transmitted to the one or more remote electronic devices 112-116 as part of the DAI inquiry. Additionally or alternatively, the one or more processors of each of the one or more remote electronic devices 112-116 may identify the instruction context information concerning the DAI based on the DAI inquiry. Continuing with the example, based on the instruction context information indicating that the one or more remote electronic devices 112-116 must be streaming music, a movie or television content, to implement to DAI, each of the one or more remote electronic devices 112-116 determines whether any application under its control is currently streaming music, a movie or television content. Based on determining whether or not any application under its control is currently streaming music, a movie or television content, each of the one or more remote electronic devices 112-116 transmits DAI response data to the local electronic device 102 and flow moves to 312.

At 312, the one or more processors receive DAI response data from each of the one or more remote electronic devices 112-116. For example, the processor 152 can direct the transceiver 162 to listen for and receive one or more responses from the one or more remote electronic devices 112-116 once the transceiver 162 transmits the DAI inquiry request. Based on receiving the one or more responses from the one or more remote electronic devices 112-116, flow moves to 314.

At 314, the one or more processors determine at least one DAI-capable remote electronic device from the one or more remote electronic devices 112-116 based on the DAI response data. For example, the processor 152 analyzes DAI response data from the responses to obtain information indicative of the capability of each remote electronic device 112-116 to implement the DAI. For example, determining that one of the one or more remote electronic devices 112-116 is capable of implementing the DAI indicates that the one of the one or more remote electronic devices 112-116 is currently streaming music, a movie or television content and is capable of implementing the DAI to pause music, a movie or television content.

Optionally, the processor 152 may analyze data from the responses to obtain additional information about each remote electronic device 112-116. Additional information may include one or more of a device name, a device location, a device manufacturer, a device make, a device model, a device version, other activities currently performed by the device, and other activities scheduled to be performed by the device. The processor 152 may use the additional information to, for example and without limitation, prompt the user for further instructions and/or format the DAI for processing on the at least one remote electronic device. Based on determining at least one DAI-capable remote electronic device from the one or more remote electronic devices 112-116, flow moves to 316.

Optionally, at 316, the one or more processors determine whether there is more than one DAI-capable remote electronic device. Based on determining there is not more than one (or that there is only one) DAI-capable remote electronic device, flow moves to 320. Based on determining that there is more than one DAI-capable remote electronic device, the process determines that further user input may be needed to implement the DAI in accordance with the intent of the user and flow moves to 318.

Optionally, at 318, the one or more processors prompt the user to specify the identity of select devices of the plurality of DAI-capable remote electronic devices on which to implement the DAI. For example, based on determining that the remote electronic device 116 in the bedroom 206, which is streaming music, and the remote electronic device 115 in the kitchen 204, which is streaming an audio book, are DAI-capable remote electronic devices, the local electronic device 102 asks the user to specify whether the user wants to pause the music streaming on the remote electronic device 116 in the bedroom 206, the audiobook streaming on the remote electronic device 115 in the kitchen 204, or neither or both.

At 320, the one or more processors transmit the DAI to the at least one DAI-capable remote electronic device for implementation thereon, and the process ends. For example, the processor 152 can direct the transceiver 162 to transmit the DAI to the at least one DAI-capable remote electronic device. Based on receiving the DAI, the at least one DAI-capable device implements the DAI, thereby pausing the music, the movie or television content without the user having to return to the location of the one or more remote electronic devices 112-116.

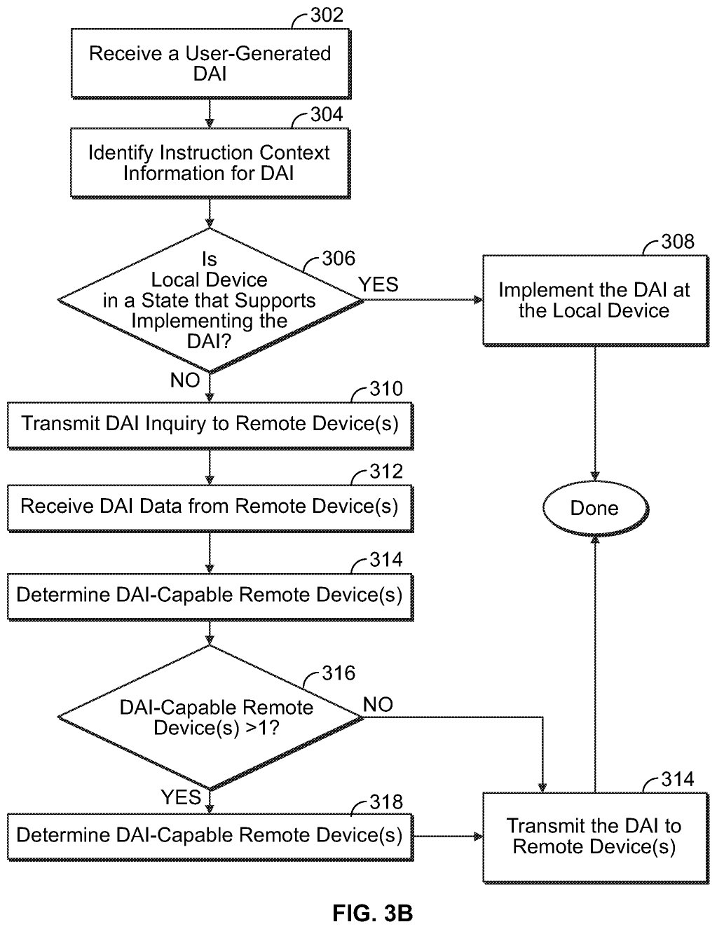

FIG. 4 illustrates an example process for managing actions of one or more remote electronic devices based on device agnostic instructions received at a local electronic device in accordance with embodiments herein. At 402, one or more processors of a local electronic device 102 receive a user-generated DAI. The local electronic device 102 may represent any type of device that includes DPA functionality. For example, the local electronic device 102 may represent an Amazon Echo® device, Google Home device, and the like. The input circuit 105 of the user interface 104 may receive the user-generated DAI. The DAI may include an instruction to, for example and without limitation, “turn off the lights” but contain no indication of any specific electronic device on which to implement the command. It is recognized that numerous other types of user instructions may be received and acted upon in connection with embodiments herein.

At 404, the one or more processors identify instruction context information concerning the DAI. The instruction context information is indicative of one or more operational states that must be present in order for the local electronic device 102 to implement the instruction. For example, for DAI that include an instruction directing an electronic device 102 to “turn off the lights” indicates that the local electronic device 102 must be operably coupled to at least one light currently in an “ON” operational state in order to implement the DAI. Once instruction context information concerning the DAI is identified, flow moves to 406.

At 406, the one or more processors determine whether the DAI can be implemented by the local electronic device 102 based on the instruction context information. For example, based on the instruction context information, the local electronic device 102 determines whether any application under control of the local electronic device 102 is operably coupled to at least one light currently in an “ON” operational state. Based on determining that an application under control of the local electronic device 102 is operably coupled to at least one light currently in an “ON” operational state, flow moves to 408. At 408, the one or more processors implement the DAI, thereby turning off the light, and the process ends. Based on determining that an application under control of the local electronic device 102 is not currently operably coupled to at least one light currently in an “ON” operational state, flow moves to 410.

At 410, the one or more processors transmit the DAI to one or more remote electronic devices 112-116 in an environment. Each of the one or more remote electronic devices 112-116 includes DPA functionality. For example, the processor 152 can direct the transceiver 162 to transmit the DAI to the one or more remote electronic devices 112-116. Based on receiving the DAI from the local electronic device 102, one or more processors of each of the one or more remote electronic devices 112-116 determine whether the DAI can be implemented thereon based on the instruction context information. The instruction context information may be transmitted to the one or more remote electronic devices 112-116 as part of the DAI. Additionally or alternatively, the one or more processors of each of the one or more remote electronic devices 112-116 may identify the instruction context information concerning the DAI based on the DAI. Continuing with the example, based on the instruction context information indicating that the one or more remote electronic devices 112-116 must be operably coupled to at least one light currently in an “ON” operational state to implement to DAI, each of the one or more remote electronic devices 112-116 determines whether any application under its control is currently operably coupled to at least one light currently in an “ON” operational state. Based on determining that an application under control of the one or more remote electronic devices 112-116 is operably coupled to at least one light currently in an “ON” operational state, the DAI is implemented, thereby turning off the light. Based on determining that an application under control of the one or more remote electronic devices 112-116 is not currently operably coupled to at least one light currently in an “ON” operational state, the DAI is not implemented.

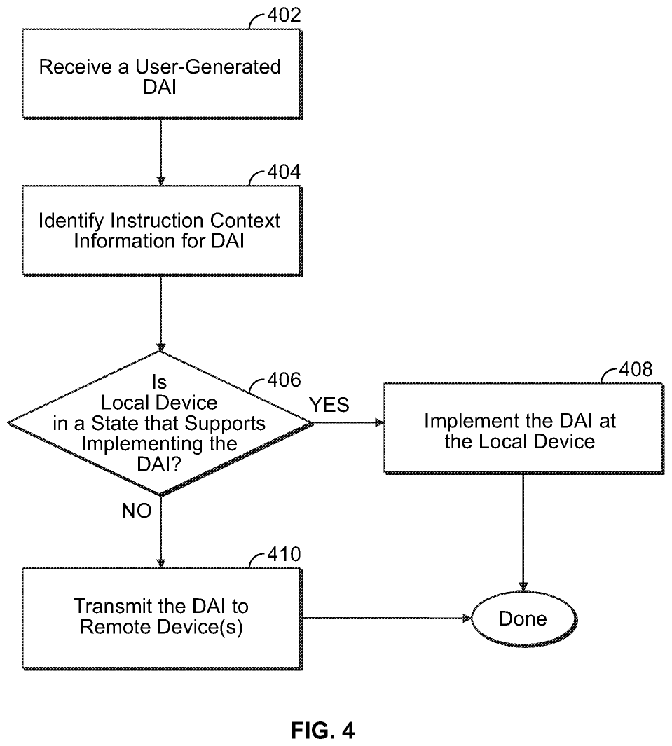

FIG. 5 illustrates an example of communications between a plurality of remote electronic devices and a local electronic device based on a DAI received at a local electronic device in accordance with embodiments herein. With reference to FIGS. 1 and 2, in one example, when a user is in the kitchen 204, the user may want to pause or turn off music streaming on the remote electronic device 116 located in the bedroom 206 (e.g., a child's bedroom) in order to facilitate obtaining the attention of a user of the remote electronic device 116. For example, a parent may desire to pause streaming of music on the remote electronic device 116 so that a child listening to the music can hear the parent ask a question. The user 212, who is near local electronic device 102, generates a DAI including a command to pause or turn off music (e.g., “pause music”, “turn off music”) without indicating any specific device on which to implement the command. The local electronic device 102 receives the DAI, identifies that the instruction context information indicates that music must be streaming in order to implement the DAI including the command to pause or turn off music, and determines that the DAI cannot be implemented on the local electronic device 102 because the operational state of streaming music does not exist. At 502, based on determining that the DAI cannot be implemented thereon, the local electronic device 102 transmits a DAI inquiry to remote electronic devices in the environment, including a first remote electronic device 114 located in the living room 202 and a second remote electronic device 116 located in the bedroom. The first and second remote electronic devices 114, 116 receive the DAI inquiry, identify that the instruction context information indicates that music must be streaming in order to implement the DAI including the command to pause or turn off music, determine whether the DAI can be implemented thereon. Based on determining whether the DAI can be implemented thereon, the first and second remote electronic devices 114, 116 transmit DAI response data to the local electronic device 102. For example, based on the first remote electronic device 114 in the living room 202 not streaming music, the first remote electronic device 114 determines that the DAI cannot be implemented thereon and, at 504, transmit DAI response data to the local electronic device 102. Further, based on the second remote electronic device 116 in the bedroom 206 streaming music, the second remote electronic device 116 would determine that the DAI can be implemented thereon and, at 404, transmit DAI response data to the local electronic device 102. The local electronic device 102 receives the DAI response data from the first and second remote electronic devices 114, 116 and determines that the remote electronic device 116 is capable of implementing the DAI including the command to pause or turn off the music. At 506, based thereon, the local electronic device 102 transmits the DAI to the remote electronic device 116. The remote electronic device 116 implements the command to pause or turn off the music streaming thereon thereby facilitating the user obtaining the attention of the user of the remote electronic device 116 without the user having to leave the kitchen 204.

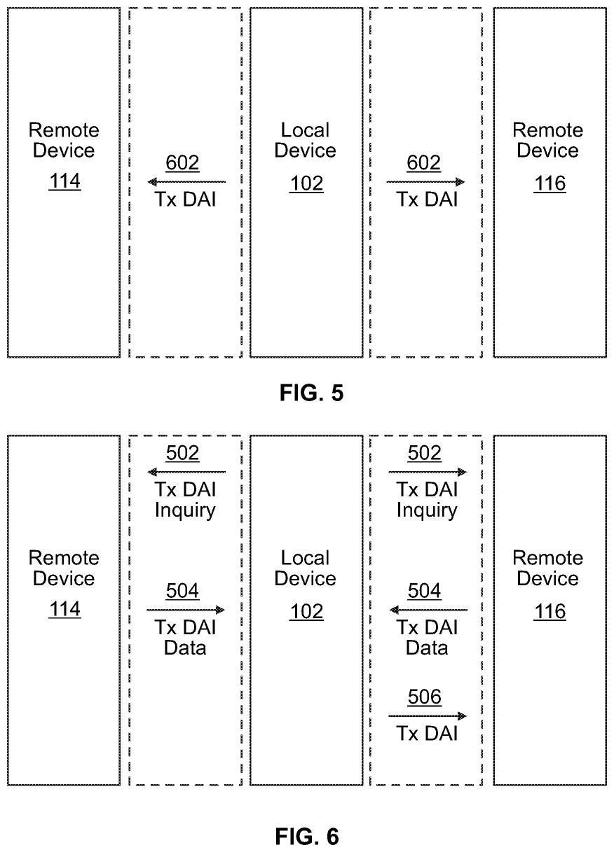

FIG. 6 illustrates an example of communications between a plurality of remote electronic devices and a local electronic device based on a DAI received at a local electronic device in accordance with embodiments herein. With reference to FIGS. 1 and 2, in one example, when a user is in the kitchen 204, the user may want to pause or turn off music streaming on one or more remote electronic devices 112-116. The user 212, who is near local electronic device 102, generates a DAI including a command to pause or turn off music (e.g., “pause music”, “turn off music”) without indicating any specific device on which to implement the command. The local electronic device 102 receives the DAI and identifies that the instruction context information indicates that music must be streaming in order to implement the DAI including the command to pause or turn off music, and determines that the DAI cannot be implemented on the local electronic device 102 because the operational state of streaming music does not exist. At 602, based on determining that the DAI cannot be implemented thereon, the local electronic device 102 transmits the DAI to remote electronic devices 112-116 in the environment, including a first remote electronic device 114 located in the living room 202 and a second remote electronic device 116 located in the bedroom. The first and second remote electronic devices 114, 116 receive the DAI, identify that the instruction context information indicates that music must be streaming in order to implement the DAI including the command to pause or turn off music, and, based on having an operational state that supports implementation of the DAI, implement the DAI. For example, based on the first remote electronic device 114 in the living room 202 not streaming music, the first remote electronic device 114 determines that the DAI cannot be implemented thereon and does not implement the DAI. Further, based on the second remote electronic device 116 in the bedroom 206 streaming music, the second remote electronic device 116 would determine that the DAI can be implemented thereon and implement the DAI.

### Closing Statements

Before concluding, it is to be understood that although e.g., a software application for undertaking embodiments herein may be vended with a device such as the system 100, embodiments herein apply in instances where such an application is e.g., downloaded from a server to a device over a network such as the Internet. Furthermore, embodiments herein apply in instances where e.g., such an application is included on a computer readable storage medium that is being vended and/or provided, where the computer readable storage medium is not a carrier wave or a signal per se.

As will be appreciated by one skilled in the art, various aspects may be embodied as a system, method or computer (device) program product. Accordingly, aspects may take the form of an entirely hardware embodiment or an embodiment including hardware and software that may all generally be referred to herein as a “circuit,” “module” or “system.” Furthermore, aspects may take the form of a computer (device) program product embodied in one or more computer (device) readable storage medium(s) having computer (device) readable program code embodied thereon.

Any combination of one or more non-signal computer (device) readable medium(s) may be utilized. The non-signal medium may be a storage medium. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a dynamic random access memory (DRAM), a read-only memory (ROM), an erasable programmable read-only memory (EPROM or Flash memory), a portable compact disc read-only memory (CD-ROM), an optical storage device, a magnetic storage device, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of network, including a local area network (LAN) or a wide area network (WAN), or the connection may be made through other devices (for example, through the Internet using an Internet Service Provider) or through a hard wire connection, such as over a USB connection. For example, a server having a first processor, a network interface, and a storage device for storing code may store the program code for carrying out the operations and provide this code through its network interface via a network to a second device having a second processor for execution of the code on the second device.

The units/modules/applications herein may include any processor-based or microprocessor-based system including systems using microcontrollers, reduced instruction set computers (RISC), application specific integrated circuits (ASICs), field-programmable gate arrays (FPGAs), logic circuits, and any other circuit or processor capable of executing the functions described herein. Additionally or alternatively, the units/modules/controllers herein may represent circuit modules that may be implemented as hardware with associated instructions (for example, software stored on a tangible and non-transitory computer readable storage medium, such as a computer hard drive, ROM, RAM, or the like) that perform the operations described herein. The above examples are exemplary only, and are thus not intended to limit in any way the definition and/or meaning of the term “controller.” The units/modules/applications herein may execute a set of instructions that are stored in one or more storage elements, in order to process data. The storage elements may also store data or other information as desired or needed. The storage element may be in the form of an information source or a physical memory element within the modules/controllers herein. The set of instructions may include various commands that instruct the units/modules/applications herein to perform specific operations such as the methods and processes of the various embodiments of the subject matter described herein. The set of instructions may be in the form of a software program. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to user commands, or in response to results of previous processing, or in response to a request made by another processing machine.

It is to be understood that the subject matter described herein is not limited in its application to the details of construction and the arrangement of components set forth in the description herein or illustrated in the drawings hereof. The subject matter described herein is capable of other embodiments and of being practiced or of being carried out in various ways. Also, it is to be understood that the phraseology and terminology used herein is for the purpose of description and should not be regarded as limiting. Further, in the following claims, phrases in the form of “at least A or B”, “A and/or B”, and “one or more of A and B” (where “A” and “B” represent claim elements), are used to encompass i) A, ii) B and/or iii) both A and B. For the avoidance of doubt, the claim limitation “one or more of a command and an action” means and shall encompass i) “one or more command”, ii) “one or more action” and/or iii) “one or more command and one or more action”.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including” and “containing” are to be construed as open-ended terms (i.e., meaning “including, but not limited to,”) unless otherwise noted. The term “connected,” when unmodified and referring to physical connections, is to be construed as partly or wholly contained within, attached to or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. The use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and the corresponding set may be equal.

Operations of processes described herein can be performed in any suitable order unless otherwise indicated herein or otherwise clearly contradicted by context. Processes described herein (or variations and/or combinations thereof) may be performed under the control of one or more computer systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory.

It is to be understood that the above description is intended to be illustrative, and not restrictive. For example, the above-described embodiments (and/or aspects thereof) may be used in combination with each other. In addition, many modifications may be made to adapt a particular situation or material to the teachings herein without departing from its scope. While the dimensions, types of materials and coatings described herein are intended to define various parameters, they are by no means limiting and are illustrative in nature. Many other embodiments will be apparent to those of skill in the art upon reviewing the above description. The scope of the embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects or order of execution on their acts.

What is claimed is:

1. A method, comprising:
under control of one or more processors configured with executable instructions;
receiving a user-generated device agnostic instruction (DAI) at a local electronic device having digital personal assistant (DPA) functionality;
determining whether the local electronic device is in an operational state that supports implementation of the DAI;
based on the determining, transmitting the DAI to one or more remote electronic devices having DPA functionality; and
implementing the DAI at each of the one or more remote electronic devices that is in an operational state that supports implementation of the DIA.

2. The method of claim 1, wherein the DAI comprises an instruction that includes one or more of a command and an action to implement and does not designate the local or remote electronic device on which to implement the one or more of the command and the action.

3. The method of claim 1, wherein transmitting the DAI includes transmitting the DAI to all of the one or more remote electronic devices having the DPA functionality.

4. The method of claim 1, further comprising:
transmitting a DAI inquiry to the one or more remote electronic devices;
receiving DAI response data from the one or more remote electronic devices;
determining at least one DAI-capable remote electronic device, from the one or more remote electronic devices, based on the DAI response data; and
transmitting the DAI to at least one DAI-capable remote electronic device for implementation thereon.

5. The method of claim 4, wherein determining at least one DAI-capable remote electronic device further comprises analyzing DAI response data to obtain information indicative of the capability of each of the one or more remote electronic devices to implement the DAI.

6. The method of claim 4, wherein the determining at least one DAI-capable remote electronic device further comprises analyzing DAI response data to obtain additional information about each of the one or more remote electronic device, the additional information including one or more of the device name, device location, device manufacturer, device make, device model, device version, other activities currently performed by the device, and other activities scheduled to be performed by the device.

7. The method of claim 4, wherein determining at least one DAI-capable remote electronic device includes determining a plurality of DAI-capable remote electronic devices based on the DAI response data; the method further comprising prompting a user to specify the identity of select devices of the plurality of DAI-capable remote electronic devices to implement the DAI on.

8. The method of claim 1, wherein the DAI includes an instruction to play, pause, or cease to play one or more of audio or video streaming content, the operational state of the local electronic device not supporting implementation of the DAI, but the operational state of at least one of the remote electronic devices supporting implementation of the DAI.

9. The method of claim 1, wherein the DAI includes an instruction to one or more of turn on a device function, turn off a device function, or adjust a setting of a device control controlled by the one or more remote electronic device.

10. A local electronic device, comprising:
an input to receive a user instruction to perform an action;
one or more processors;
a memory storing program instructions accessible by the one or more processors, wherein, responsive to execution of the program instructions, the one or more processors perform the following:
receive a user-generated device agnostic instruction (DAI) at the local electronic device having digital personal assistant (DPA) functionality;
determine whether the local electronic device is in an operational state that supports implementation of the DAI;
based on the determine, transmit the DAI to one or more remote electronic devices having DPA functionality; and
implement the DAI at each of the one or more remote electronic devices in an operational state that supports implementation of the DIA; and
a transceiver to transmit the DAI to the one or more remote electronic device.

11. The device of claim 10, wherein the DAI comprises an instruction that includes one or more of a command or an action to implement and does not designate the local or remote electronic device on which to implement the one or more of the command and the action.

12. The device of claim 10, wherein the one or more processors are further configured to:
transmit a DAI inquiry to the one or more remote electronic devices;
receive DAI response data from the one or more remote electronic devices;
determine at least one DAI-capable remote electronic device, from the one or more remote electronic devices, based on the DAI response data; and
transmit the DAI to at least one DAI-capable remote electronic device for implementation thereon.

13. The device of claim 12, wherein the one or more processor are configured to, as part of the determine at least one DAI-capable remote electronic device, analyze DAI response data to obtain information indicative of the capability of each of the one or more remote electronic devices to implement the DAI.

14. The device of claim 12, wherein the one or more processor are configured to, as part of the determine at least one DAI-capable remote electronic device, analyze DAI response data to obtain additional information about each of the one or more remote electronic device, the additional information including one or more of the device name, device location, device manufacturer, device make, device model, device version, other activities currently performed by the device, and other activities scheduled to be performed by the device.

15. The device of claim 12, wherein the one or more processor are configured to, as part of the determine at least one DAI-capable remote electronic device, determine a plurality of DAI-capable remote electronic devices based on the DAI response data; wherein the one or more processor are further configured to prompt a user to specify the identity of select devices of the plurality of DAI-capable remote electronic devices to implement the DAI on.

16. The device of claim 10, wherein the one or more processors are configured to:
determine that the local electronic device is in an operational state that supports implementation of the DAI;
implement the DAI in connection with the operational state of the DPA functionality of the local electronic device; and
further transmit the DAI to the one or more remote electronic devices having the DPA functionality for implementation at each of the one or more remote electronic devices in the operational state that supports implementation of the DIA.

17. A computer program product comprising a non-signal computer readable storage medium comprising computer executable code to:
receive a user-generated device agnostic instruction (DAI) at a local electronic device having digital personal assistant (DPA) functionality;
determine whether the local electronic device is in an operational state that supports implementation of the DAI;
based on the determine, transmit the DAI to one or more remote electronic devices having DPA functionality; and
implement the DAI at each of the one or more remote electronic devices in an operational state that supports implementation of the DIA.

18. The computer program product of claim 17, wherein the DAI comprises an instruction that includes one or more of a command or an action to implement and does not designate the local or remote electronic device on which to implement the one or more of the command and the action.

19. The computer program product of claim 17, further comprising computer executable code to:
transmit a DAI inquiry to the one or more remote electronic devices;
receive DAI response data from the one or more remote electronic devices;
determine at least one DAI-capable remote electronic device, from the one or more remote electronic devices, based on the DAI response data; and
transmit the DAI to at least one DAI-capable remote electronic device for implementation thereon.

20. The computer program product of claim 19, further comprising computer executable code to, as part of the determine at least one DAI-capable remote electronic device, analyze DAI response data to obtain information indicative of the capability of each of the one or more remote electronic devices to implement the DAI.
